(19) United States
(12) Patent Application Publication
(10) Pub. No.: US 2022/0137644 A1
(43) Pub. Date: May 5, 2022

(54) DRONE SYSTEM, DRONE, CONTROL METHOD FOR DRONE SYSTEM, AND DRONE SYSTEM CONTROL PROGRAM

(71) Applicant: NILEWORKS INC., Tokyo (JP)

(72) Inventors: Chihiro WAKE, Tokyo (JP); Hiroshi YANAGISHITA, Tokyo (JP)

(21) Appl. No.: 17/429,976

(22) PCT Filed: Feb. 7, 2020
(86) PCT No.: PCT/JP2020/004926

§ 371 Date: Aug. 11, 2021

(30) Foreign Application Priority Data
Feb. 12, 2019 (JP) 2019-022942
Jul. 23, 2019 (JP) 2019-135064
Jul. 30, 2019 (JP) 2019-139710

(51) Int. Cl. G05D 1/10; B64C 39/02; B64F 1/36; G06Q 10/06; G08G 5/00

(52) U.S. Cl. CPC G05D 1/104; B64C 39/024; B64F 1/36; G06Q 10/06312; B64D 1/16; G08G 5/0008; B64C 2201/027; B64C 2201/12; B64C 2201/14; G08G 5/0039

(57) ABSTRACT

A drone system causes a plurality of drones to perform an operation in a predetermined area in a sharing manner, wherein each of the plurality of drones holds at least one decreasing factor that is to be consumed when a corresponding drone is operated, and on condition that replenishment or refreshment with the factor needs return to the takeoff-landing port, when at least one of the drones returns to the takeoff-landing port, the drone system calculates and compares a time t_{A} and a time t_{B}, the time t_{A} being a time taken by the drone to be replenished or refreshed with the decreasing factor and to take off again, the time t_{B} being a time taken to allocate all operations remaining at a time of the return to drones not having returned and cause the drones not having returned to perform all remaining operations.

### TECHNICAL FIELD

The invention of the present application relates to a drone system, a drone, a control method for a drone system, and a drone system control program.

### BACKGROUND ART

Application of a small helicopter (multicopter) generally called a drone has progressed. One of important fields of the application is spreading chemical agent, such as agrochemical and liquid fertilizer, over farmland (an agricultural field) (e.g., see Patent Literature 1). For relatively narrow farmland, using a drone rather than a piloted airplane or helicopter is often suitable.

Thanks to a technology such as a quasi-zenith satellite system and a real time kinematic-global positioning system (RTK-GPS), it is possible to grasp an absolute position of a drone in flight accurately down to several centimeters, thereby enabling autonomous flight with a minimum of manual control and efficient, accurate spreading of chemical agent even in farmland having a narrow, complicated terrain, which is typically seen in Japan.

For causing a drone to fly over an agricultural field to perform an operation such as spreading chemical agent as described above, it is proposed to cause a plurality of drones to fly at the same time for dealing with a relatively large agricultural field or for shortening an operating time (e.g., Patent Literature 3). That is, what is proposed is that traveling routes are planned for the drones to cause the drones to perform an operation in an agricultural field in a sharing manner.

However, in a case where the plurality of drones are used in this manner to perform an operation in an agricultural field in a sharing manner, a completion time of the operation is bottlenecked by operation of a drone operating most slowly because the traveling routes of the drones planned in advance cannot be changed. In general, completion of an operation in an agricultural field usually requires a several times of replenishment with loaded items such as agrochemical to be spread by drones, and therefore the drones shuttle between their posts in the operation and a takeoff-landing port for the replenishment with the loaded items while performing the operation. In addition, in a case of rechargeable drones, their battery consumptions cannot be predicted precisely due to influence of ambient temperature and wind, and therefore their available flight time periods vary to some extent, which raises a necessity of a return to a takeoff-landing port for replacement or electric recharging of their batteries. Due to these causes, even in a case where an operation is divided in advance evenly among a plurality of drones, a difference arises in operation progress status among the drones; consequently, operation of a drone operating most slowly bottlenecks, and thus there is a desire to ameliorate the bottleneck.

### CITATION LIST

### Patent Literature

### [Patent Literature 1]

Japanese Patent Laid-Open No. 2001-120151

### [Patent Literature 2]

WO 2014/160589

### SUMMARY OF INVENTION

### Technical Problem

For a drone system that uses a plurality of drones and operates the drones in automatic flight to perform operations along flight routes assigned to the drones in areas on which the operations are performed, an object of the present invention is to provide a drone system that brings efficiency to the operations to shorten an operating time.

### Solution to Problem

A drone system according to an aspect of the invention of the present application to achieve the objects described above is a drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner, wherein

each of the plurality of drones holds at least one decreasing factor that is to be consumed when a corresponding drone is operated, and on condition that replenishment or refreshment with the factor needs the drones to return to the takeoff-landing port,

when at least one of the drones returns to the takeoff-landing port, in a case where it is determined that the factor held by each of drones not having returned is sufficient for the drones not having returned to perform all remaining operations, the drone system can allocate and redistribute all remaining operations to the drones not having returned and can change flight routes of the drones.

The decreasing factor may be at least one selected from the group consisting of an amount of driving energy of a drone (a charge amount of a battery, an amount of fuel, etc.) and an amount of substance loaded in the drone (an amount of chemical agent such as agrochemical and fertilizer to be spread, an amount of seed to be spread, etc.).

In a case where a return of the at least one of the drones to the takeoff-landing port is for replenishment or refreshment with the decreasing factor, the drone system may calculate and compare a time t_{A} and a time t_{B}, the time t_{A} being a time taken by the at least one of the drones to be replenished or refreshed with the decreasing factor and to take off again, the time t_{B} being a time taken to allocate all operations remaining at a time of the return to drones not having returned and cause the drones not having returned to perform all remaining operations, and may determine whether to redistribute all remaining operations to the drones not having returned based on at least a result of the comparison.

In a case where the comparison of t_{A} and t_{B} results in t_{A}>t_{B}, and it is determined that the factor held by each of drones not having returned is sufficient for the drones not having returned to perform all remaining operations, the drone system may allocate and redistribute all remaining operations to the drones not having returned and may change flight routes of the drones.

A return of the at least one of the drones to the takeoff-landing port may be based on an optional return command from an operator.

The drone system may switch whether to compare t_{A} and t_{B} in accordance with whether or not a return of the at least one of the drones to the takeoff-landing port is for replenishment or refreshment with the decreasing factor or based on an optional return command from an operator.

In accordance with whether a return of the at least one of the drones to the takeoff-landing port is for replenishment or refreshment with the decreasing factor or based on an optional return command from an operator, in a case where the comparison of t_{A} and t_{B} shows that t_{A}>t_{B}, and it is determined that the factor held by each of drones not having returned is sufficient for the drones not having returned to perform all remaining operations, the drone system may switch between conditions including: a condition of allocating and redistributing all remaining operations to the drones not having returned and changing the flight routes of the drones; and a condition of allocating and redistributing all remaining operations immediately to the drones not having returned and changing the flight routes of the drones.

Redistribution of all remaining operations may be determined based on an estimated required time on all remaining operations or determined based on an estimated remaining amount of the decreasing factor.

The redistribution may be an allocation performed by newly setting an optimum route again based on a remaining area rather than allocation by allocating an original route for the drone having returned in a shared manner.

Each drone may detect a state of the decreasing factor of the corresponding drone and transmit the state to the flight control section whenever necessary.

The takeoff-landing port may be provided on a movable body that is capable of moving with the drone aboard and operates in coordination with the drone.

A control method for a drone system according to an aspect of the invention of the present application to achieve the object described above is a control method for a drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner, the control method including

each of the plurality of drones includes at least one decreasing factor that is to be consumed when a corresponding drone is operated, and on condition that replenishment or refreshment with the factor needs return to the takeoff-landing port,

a step of detecting all remaining operations when at least one of the drones returns to the takeoff-landing port; a step of determining whether the factor held by each of drones not having returned is sufficient for the drones not having returned to perform all remaining operations; and a step of allocating and redistributing all detected remaining operations to drones not having returned and changing flight routes of the drones.

The control method for a drone system may include: a step of calculating and comparing, when at least one of the drones returns to the takeoff-landing port, a time t_{A} and a time t_{B}, the time t_{A} being a time taken by the drone having returned to be replenished or refreshed with the decreasing factor and to take off again, the time t_{B} being a time taken to allocate all operations remaining at a time of the return to drones not having returned and cause the drones not having returned to perform all remaining operations; and a step of determining whether the comparison results in t_{A}>t_{B} and the factor held by each of drones not having returned is sufficient for the drones not having returned to perform all remaining operations, wherein the drone system may perform, in accordance with a result of the determination, the step of allocating and redistributing all detected remaining operations to drones not having returned and changing flight routes of the drones.

A drone system control program according to an aspect of the invention of the present application to achieve the object described above is a control program for a drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner, wherein each of the plurality of drones includes at least one decreasing factor that is to be consumed when a corresponding drone is operated, and on condition that replenishment or refreshment with the factor needs a return to the takeoff-landing port, the control program causes a computer to execute: a command to detect all remaining operations when at least one of the drones returns to the takeoff-landing port; a command to determine whether the factor held by each of drones not having returned is sufficient for the drones not having returned to perform all remaining operations; and a command to allocate and redistribute all detected remaining operations to drones not having returned and change flight routes of the drones.

Note that the computer program may be provided by download over a network such as the Internet or may be provided by being recorded in one of various kinds of computer-readable recording media such as a CD-ROM.

The control program may cause a computer to execute: a command to detect all remaining operations; a command to calculate and compare a time t_{A} and a time t_{B}, the time t_{A} being a time taken by the drone having returned to be replenished or refreshed with the decreasing factor and to take off again, the time t_{B} being a time taken to allocate all operations remaining at a time of the return to drones not having returned and cause the drones not having returned to perform all remaining operations; a command to determine whether the comparison results in t_{A}>t_{B} and the factor held by each of drones not having returned is sufficient for the drones not having returned to perform all remaining operations; and a command to allocate and redistribute all remaining operations to drones not having returned and change flight routes of the drones.

A drone according to an aspect of the invention of the present application to achieve the object described above is a drone that is capable of taking off from and making a landing on a takeoff-landing port and capable of flying along an assigned flight route while being controlled by a flight control section, the drone holding at least one decreasing factor that is to be consumed when the corresponding drone is operated, the drone holding: a detection section that detects a state of the decreasing factor; and a transmission section that transmits state information obtained by the detection section to the flight control section whenever necessary, wherein the drone changes the flight route in accordance with a change of the flight route transmitted from the flight control section.

### Advantageous Effects of Invention

In a drone system that uses a plurality of drones and operates the drones in automatic flight to perform operations along flight routes assigned to the drones in areas on which the operations are performed, even when a difference arises in operation progress status among the drones, allocation of the operations to the drones can be redistributed when one or more of the drones returns to a takeoff-landing port temporarily, so that it is possible to bring efficiency to the operations, and an operating time can be shortened. Furthermore, even in a case where an operator optionally withdraws one or more of the drones, it is possible to complete the remaining operations smoothly.

### BRIEF DESCRIPTION OF DRAWINGS

FIG. 1 is a plan view illustrating a first embodiment of a drone system according to the invention of the present application.

FIG. 2 is a front view of a drone included in the drone system.

FIG. 3 is a right side view of the drone.

FIG. 4 is a rear view of the drone.

FIG. 5 is a perspective view of the drone.

FIG. 6 is a general schematic diagram of a chemical-agent spreading system included in the drone.

FIG. 7 is a general schematic diagram illustrating a second embodiment of the chemical-agent spreading system included in the drone.

FIG. 8 is a general schematic diagram illustrating a third embodiment of the chemical-agent spreading system included in the drone.

FIG. 9 is a general schematic diagram illustrating a state when operating segments for drones are reviewed in an embodiment of the chemical agent spreading system illustrated in FIG. 6.

FIG. 10 is a general schematic diagram illustrating a state after the operating segments for drones are redistributed in the embodiment of the chemical agent spreading system illustrated in FIG. 6.

FIG. 11 is a schematic diagram illustrating control functions of the drone.

FIG. 12 is a schematic perspective view of a scene of a movable body used in an embodiment of the invention of the present application.

FIG. 13 is a schematic perspective view of the movable body illustrating how an upper plate on which the drone is placed is slid rearward.

FIG. 14 is a functional block diagram concerning functions included in the drone and the movable body.

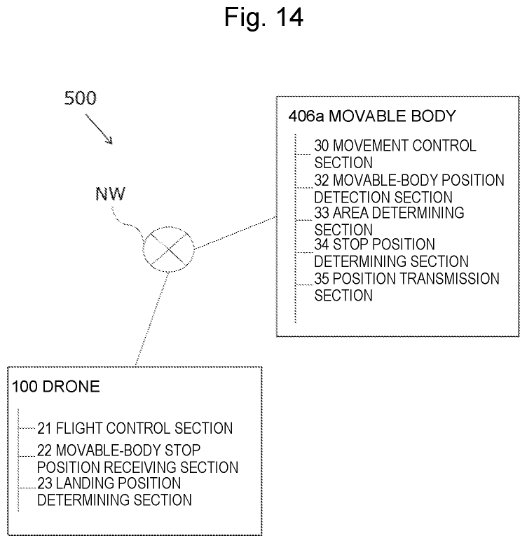

FIG. 15 is a flowchart of how the drone system redistributes operations when a drone returns temporarily.

### DESCRIPTION OF EMBODIMENTS

Embodiments for carrying out the invention of the present application will be described below with reference to the drawings. The drawings are all for exemplification purposes. In a detailed description to be made below, specific details will be described for explanation and for helping complete understanding of disclosed embodiments. However, embodiments are not limited to these specific details. In addition, well-known structures and devices are illustrated schematically for simplification of the drawings.

The invention of the present application is about a drone system that causes the plurality of drones to perform an operation in a predetermined area in a sharing manner. The predetermined area is not particularly limited; for example, in a case where the drones are used in agricultural use, the predetermined area is typically a farmland (agricultural field), and in a case where the drones are used in other uses such as capturing images for some purpose and firefighting operation, the predetermined area may be an area other than the farmland, for example, various kinds of land such as an urban area, a suburban area, and a mountainous area, and a sea area. Note that a position, a size, and the like of an area to be subjected to an operation are desirably determined in advance.

According to the invention of the present application, a plurality of drones are used as described above; first, a configuration of a drone included in a drone system according to the invention of the present application will be described. In the present specification, a drone generally refers to an aerial vehicle including a plurality of rotary wings irrespective of its type of motive power (electric motor, heat engine, etc.) and its type of control (wireless or wired, autonomous flight or manual control, etc.)

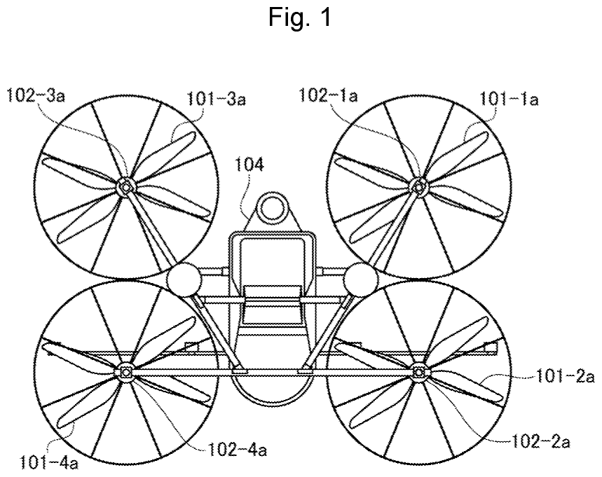

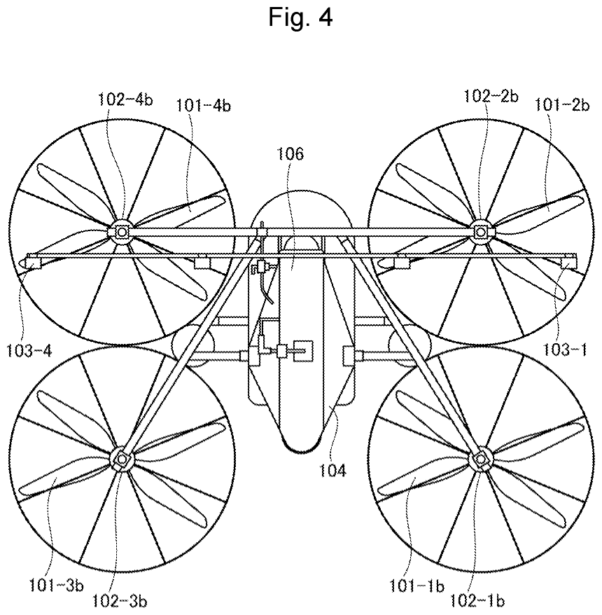

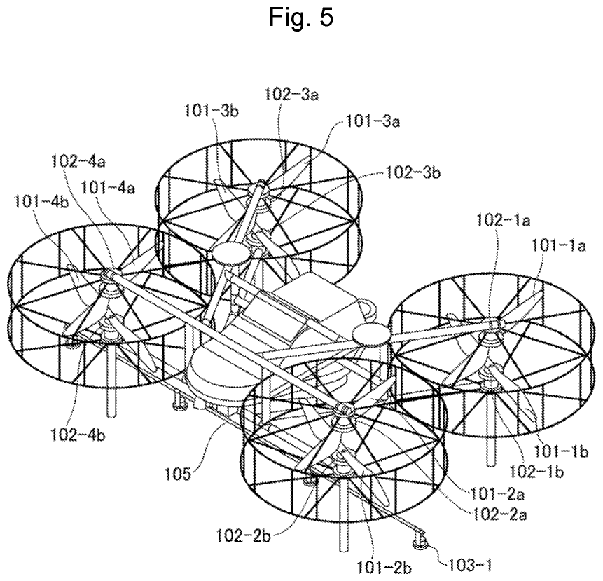

As illustrated in FIG. 1 to FIG. 5, rotary wings 101-1a, 101-1b, 101-2a, 101-2b, 101-3a, 101-3b, 101-4a, and 101-4b (also referred to as rotors) are means for causing a drone 100 to fly, and eight rotary wings (four sets of double-tier rotary wings) are provided, with consideration given to balance of stability of flight, a size of an airframe, and power consumption. The rotary wings 101 are arranged at positions in four directions from a main body 110 of a drone 100, supported by arms extending from the main body 110. That is, as viewed in a traveling direction of the drone 100, the rotary wings 101-1a and 101-1b are arranged behind the main body 110 on the left, the rotary wings 101-2a and 101-2b are arranged ahead of the main body 110 on the left, the rotary wings 101-3a and 101-3b are arranged behind the main body 110 on the right, and the rotary wings 101-4a and 101-4b are arranged ahead of the main body 110 on the right. Note that a traveling direction of the drone 100 is a downward direction of the paper of FIG. 1. Below the rotary wings 101, rod-shaped legs 107-1, 107-2, 107-3, and 107-4 extend along rotation axes of the rotary wings 101.

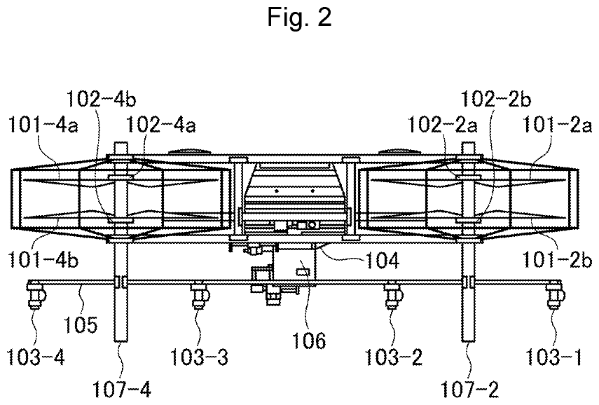

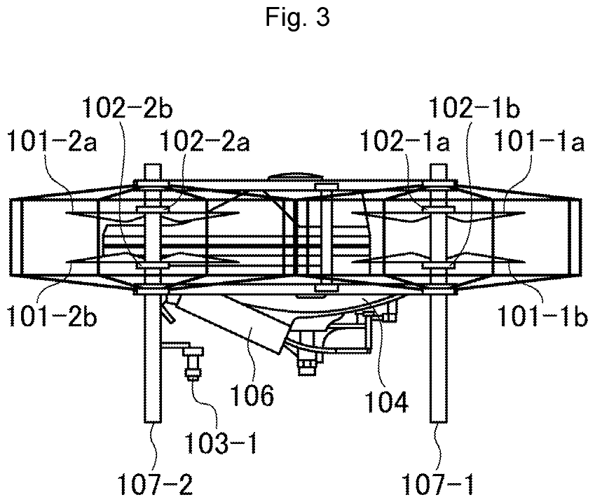

Motors 102-1a, 102-1b, 102-2a, 102-2b, 102-3a, 102-3b, 102-4a, and 102-4b are means for causing the rotary wings 101-1a, 101-1b, 101-2a, 101-2b, 101-3a, 101-3b, 101-4a, and 101-4b to rotate (typically electric motors but may be engines, etc.), respectively, and are each provided for one rotary wing. The motors 102 exemplify thrusters. Up and down rotary wings of one of the sets (e.g., 101-1a and 101-1b) and their respective motors (e.g., 102-1a and 102-1b) include axes lying on the same line and rotate in directions opposite to each other for stability of flight of the drone and the like. As illustrated in FIG. 2 and FIG. 3, radial members for supporting propeller guards, which are provided to prevent the rotors from interfering with a foreign object, each have a turreted structure rather than a flat structure. This is because, in a case of a collision, this structure urges the member to buckle outward of the rotary wing, preventing the member from interfering with the rotor.

Chemical agent nozzles 103-1, 103-2, 103-3, and 103-4 are means for spreading chemical agent downward, and the number of the provided chemical agent nozzles is four. Note that, in the present specification, the chemical agent generally refers to liquid or powder to be spread over an agricultural field, such as agrochemical, herbicide, liquid fertilizer, powdery fertilizer, insecticide, seeds, and water.

A chemical agent tank 104 is a tank for storing chemical agent to be spread and is provided at a position close to and below a center of gravity of the drone 100, from a viewpoint of weight balance. Chemical agent hoses 105-1, 105-2, 105-3, and 105-4 are means for connecting the chemical agent tank 104 and the chemical agent nozzles 103-1, 103-2, 103-3, and 103-4, are made of a hard material, and may additionally play a role of supporting the chemical agent nozzles. A pump 106 is means for discharging the chemical agent from the nozzles.

The drone system according to the invention of the present application uses a plurality of drones each having the configuration as exemplified above and uses states of decreasing factors that are consumed during the operations of the drones, and replenishment and refreshment of which require their returns to a takeoff-landing port, as a basis for determination in controlling operations of the drones. Examples of the decreasing factors include an amount of driving energy of a drone, an amount of substance loaded in the drone, and the like. In addition to these, conceivable factors include a consecutive operating time of a motor and the like; however, in general, the amount of driving energy of a drone and the amount of substance loaded in the drone are factors that significantly change with time (have large reduction rates), and thus it is preferable to use states of these factors as the basis for determination. Additionally, as a decreasing factor in the drone system according to the invention of the present application, for example, only one of an amount of driving energy of a drone and an amount of substance loaded in the drone can and may be used as the basis for determination.

More specifically, an amount of driving energy of a drone is a charge amount of a battery, an amount of fuel, or the like, which depends on the type of motive power used for the drone, and in a case of agricultural use, an amount of substance loaded in the drone is a chemical agent amount as described above (an amount of agrochemical, herbicide, liquid fertilizer, powdery fertilizer, insecticide, seed, water, etc. to be spread, an amount of seed to be seeded, etc.).

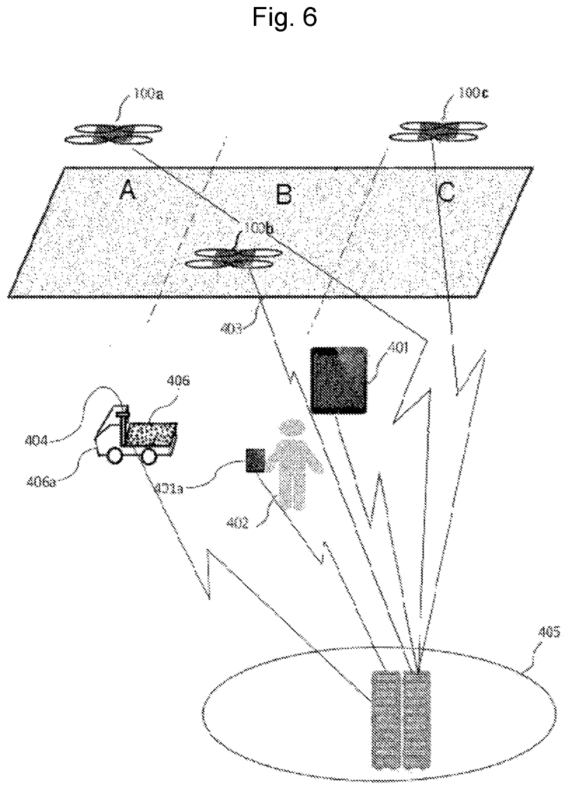

FIG. 6 illustrates a general schematic diagram of a system to which an embodiment of the drone system according to the invention of the present application in chemical agent spreading use is applied. This figure is schematic, and its scale is not exact. In this figure, a plurality of drones 100a, 100b, and 100c, an operating device 401, a small portable terminal 401a, a base station 404, and a movable body 406a are connected to an agriculture cloud 405. These constituents of the system may be connected by wireless communication such as Wi-Fi and a mobile telecommunications system, or some or all of them may be connected in a wired manner. Although the drone system operates the three drones 100a, 100b, and 100c in the present embodiment, the number of the drones may be any number more than one, that is, two or more. The movable body 406a includes a takeoff-landing port 406. Although the takeoff-landing port 406, which allows the drones 100 to take off from it and make a landing on it, is provided on the movable body 406a in the present embodiment, an installation location of the takeoff-landing port 406 in the invention of the present application is not particularly limited to such an installation location as one on the movable body 406a, and the takeoff-landing port 406 of course can be provided fixedly on the ground. In addition, although it is sufficient that one takeoff-landing port 406 allows at least one drone 100 to take off from it or make a landing on it, the takeoff-landing port 406 may allow two or more drones 100 to take off from it or make a landing on it at the same time, or one drone system may be provided with a plurality of takeoff-landing ports 406.

The drones 100a, 100b, and 100c and the movable body 406a exchange information with each other to operate in coordination with one another. The drones 100a, 100b, and 100c include flight control sections 21 that control flights of the drones 100a, 100b, and 100c, respectively, and each include a functional section for exchanging information with the movable body 406a.

The operating device 401 is means for sending a command to each of the drones 100a, 100b, and 100c in response to an operation made by a user 402 and for displaying information received from each of the drones 100a, 100b, and 100c (e.g., position, chemical agent amount, remaining battery level, image taken by a camera, etc.) and may be implemented in a form of mobile information equipment such as a typical tablet terminal on which a computer program runs. The drones 100a, 100b, and 100c according to the invention of the present application are controlled so as to perform autonomous flight and may be configured to allow manual operation in basic operations such as a takeoff and a return and in an emergency situation. In addition to the mobile information equipment, an emergency operating device (not illustrated) having a dedicated function of making an emergency stop may be used. The emergency operating device may be dedicated equipment provided with a large emergency stop button or the like for dealing speedily with an emergency situation. Moreover, a small portable terminal 401a, such as a smartphone, capable of displaying some or all of pieces of information to be displayed on the operating device 401 may be included in the system in addition to the operating device 401. The system may have a function of changing behavior of the drones 100a, 100b, and 100c based on information received from the small portable terminal 401a. The small portable terminal 401a is connected to, for example, the base station 404, being capable of receiving information and the like from the agriculture cloud 405 via the base station 404.

An agricultural field 403 is a rice field, field, or the like that is to be spread with chemical agent by the drones 100a, 100b, and 100c. In reality, topographic features of the agricultural field 403 are complex, and there is a case where no topographic map is available in advance or a case where a given topographic map disagrees with site conditions of the agricultural field 403. In addition, ambient temperature and wind at the agricultural field 403 may have influence. Due to these causes, even when the agricultural field 403 is divided into, for example, zones having an equal area (zone A, zone B, and zone C) that are assigned to the drones 100a, 100b, and 100c, agrochemical spreading operations by the drones 100a, 100b, and 100c or consumptions of batteries or fuel in the drones 100a, 100b, and 100c do not always proceed evenly.

The base station 404 is a device providing a host unit function and the like in Wi-Fi communication and may be configured to function also as an RTK-GPS base station to provide accurate positions of the plurality of drones 100a, 100b, and 100c. In the base station 404, the host unit function in the Wi-Fi communication and the RTK-GPS base station may be implemented as independent devices. The base station 404 may be capable of communicating mutually with the agriculture cloud 405 using a mobile telecommunications system such as 3G, 4G, and LTE. In the present embodiment, the base station 404 is loaded on a movable body 406a together with the takeoff-landing port 406.

An agriculture cloud 405 typically includes computers and relevant software operated on a cloud computing service and may be wirelessly connected to the operating device 401 over a mobile telephone line or the like. The agriculture cloud 405 may analyze images of the agricultural field 403 captured by the drones 100a, 100b, and 100c, grasp growth conditions of a crop, and perform processing for determining flight routes. In addition, the agriculture cloud 405 may provide topographic information and the like on the agricultural field 403 stored therein to the drones 100a, 100b, and 100c. Moreover, the agriculture cloud 405 may accumulate records of flights of the drones 100a, 100b, and 100c and images captured by the drones 100a, 100b, and 100c and perform various kinds of analyses thereon.

The small portable terminal 401a is an example of a portable terminal; for example, the small portable terminal 401a is a smartphone or the like. The small portable terminal 401a includes a display section that displays, as appropriate, information on actions predicted in relation to the operations of the drones 100a, 100b, and 100c, more specifically, scheduled times at which the drones 100 are to return to the takeoff-landing port 406 and information on details and the like of operations to be performed by the user 402 after the drones 100 return. Based on an input performed on the small portable terminal 401a, behavior of the drones 100a, 100b, and 100c and the movable body 406a may be changed. The portable terminal is capable of receiving information from any one of the drones 100a, 100b, and 100c and the movable body 406a. The information from the drones 100a, 100b, and 100c may be sent to the small portable terminal 401a via the movable body 406a.

In general, the drones 100a, 100b, and 100c each take off from the takeoff-landing port 406 located outside the agricultural field 403, spread chemical agent over the agricultural field 403, and return to the takeoff-landing port 406 after the spreading or when replenishment with chemical agent, electric recharging, or the like is needed. Flight routes (entrance routes) from the takeoff-landing port 406 to the agricultural field 403 as a destination may be stored in advance in the agriculture cloud 405 or the like or may be input by the user 402 before the takeoff.

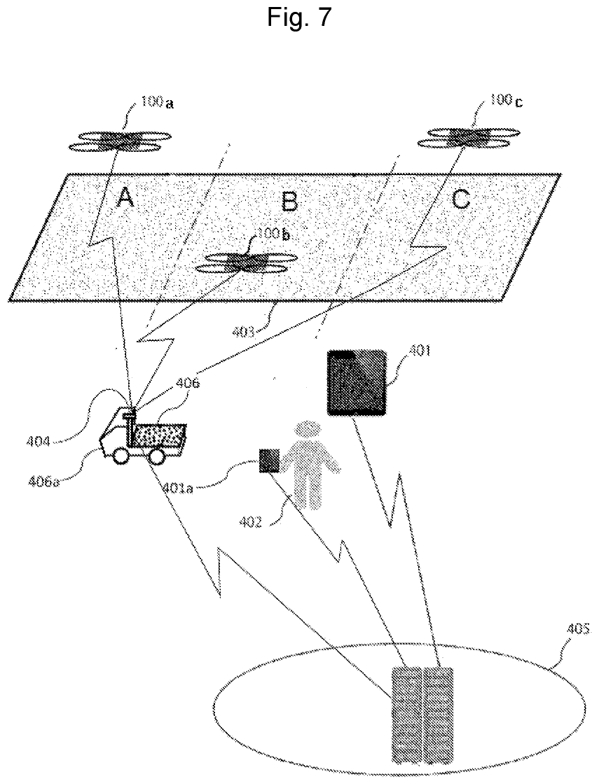

Note that, as in a second embodiment illustrated in FIG. 7, a chemical-agent spreading system with the drones 100a, 100b, and 100c according to the invention of the present application may have a configuration in which the drones 100a, 100b, and 100c, the operating device 401, the small portable terminal 401a, and the agriculture cloud 405 are connected to the base station 404.

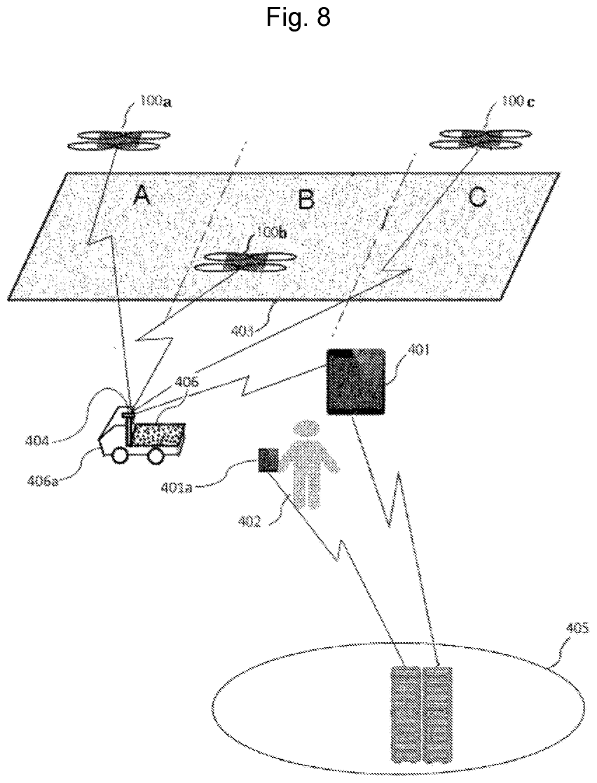

Alternatively, as in a third embodiment illustrated in FIG. 8, the chemical-agent spreading system with the drones 100a, 100b, and 100c according to the invention of the present application may have a configuration in which the drones 100a, 100b, and 100c, the operating device 401, and the small portable terminal 401a are connected to the base station 404, and only the operating device 401 is connected to the agriculture cloud 405.

As illustrated in FIG. 6 to FIG. 8, the drones 100 fly over their assigned zones (zone A, zone B, and zone C) originally given in the agricultural field 403 to execute their operations in the agricultural field.

The drones 100a, 100b, and 100c take off from the movable body 406a and execute the operations in the agricultural field 403. The drones 100a, 100b, and 100c each suspend its operation during the operation in the agricultural field 403 as appropriate and return to the movable body 406a, where replenishment with a battery 502 and chemical agent is performed. Upon completion of an operation in a predetermined agricultural field, each of the drones 100a, 100b, and 100c is moved aboard the movable body 406a to a vicinity of another agricultural field and then takes off from the movable body 406a again to start an operation in the other agricultural field. In this manner, the movement of the drones 100a, 100b, and 100c to the other agricultural field is performed while the drones 100a, 100b, and 100c are aboard the movable body 406a in principle, and the movable body 406a transports the drones 100 to a vicinity of an agricultural field where operations are to be performed. With this configuration, batteries 502 of the drones 100 can be saved. In addition, since the movable body 406a stores batteries 502 and chemical agent with which the drones 100 can be replenished, a configuration in which the movable body 406a moves to and is on standby at a vicinity of an agricultural field where the drones 100 are in operation, a time necessary for the replenishment of the drones 100 can be shortened.

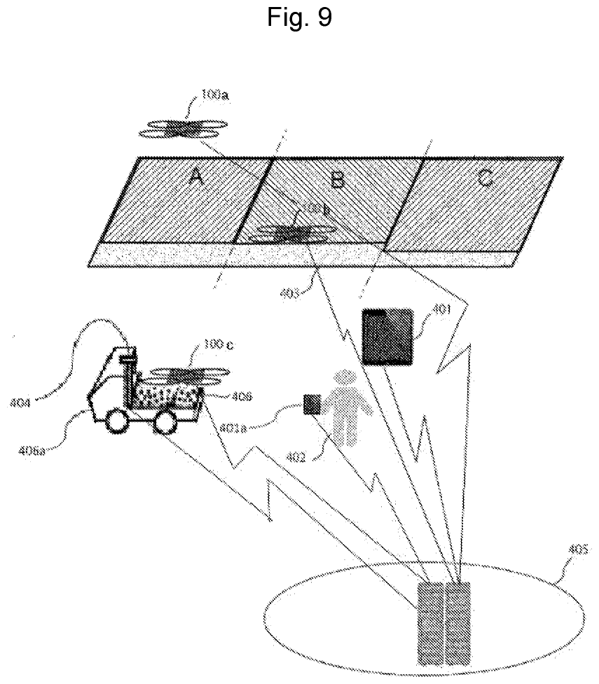

FIG. 9 schematically illustrates a state where chemical agent spreading operations by the drones proceed in the embodiment illustrated in FIG. 6, and the drone 100c returns to the takeoff-landing port 406 because replenishment with chemical agent, electric recharging, or the like of the drone 100c becomes necessary. In the invention of the present application, at this time, that is, when at least one of the drones returns to the takeoff-landing port, allocation of the assigned zones to the drones is reviewed.

That is, a time t_{A}, which is taken by the drone 100c having returned to be replenished or refreshed with the decreasing factors, which include replenishment with chemical agent or electric recharging in this example, and to take off again, and a time t_{B}, which is taken to allocate all operations remaining at a time of the return to the drones 100a and 100b not having returned and cause the drones 100a and 100b not having returned to perform all remaining operations, are calculated and compared with each other, and it is determined whether the comparison results in t_{A}>t_{B} and the factors held by the drones 100b and 100c not having returned, that is, chemical agent amounts and charge amounts, are sufficient for the drones 100a and 100b not having returned to perform all remaining operations. FIG. 9 schematically illustrates degrees of progress of operations in the zone A, the zone B, and the zone C assigned to the drones 100a, 100b, and 100c, respectively, at the time when the drone 100c returns to the takeoff-landing port 406, where areas in which the operations have already been finished in the respective zones are hatched in the figure. For ease of understanding, suppose numeric values are given to the degrees of progress; for example, the degrees of progress of the operations in the zone A and the zone B are both 80%, and the degree of progress of the operation in the zone C is 85%, which however should not be construed as limiting the numeric values at all. This is because, for example, in a case where the operations in the respective zones have all proceeded considerably, and remaining operations are little, as illustrated in FIG. 9, it is possible to advance an operation finishing time as a whole by allocating and redistributing all remaining operations (in this example, 20% in the zone A, 20% in the zone B, and 15% in the zone C) to the drones 100a and 100b not having returned and causing the drones 100a and 100b to perform the allocated and redistributed operations rather than causing the drone 100c having returned to come back again to the assigned zone (zone C) and perform its remaining operation after replenishment of chemical agent and electric recharging are finished.

Regarding actual degrees of progress of the operations by the drones 100a, 100b, and 100c, for the drones 100a and 100b being flying, their actual degrees of progress can be calculated by, for example, comparing pieces of information on current flight positions received from the drones 100a and 100b with originally set flight routes using a computer program in the operating device 401 or the agriculture cloud 405, and for the drone 100c having returned, its actual degree of progress can be calculated by, for example, comparing a piece of information on a flight position in the operating zone (zone C) received from the drone 100c immediately before the return with an originally set flight route similarly.

In addition, for remaining chemical agent amounts and charge amounts of the drones 100a and 100b being flying, pieces of information received by the operating device from the drones 100a and 100b can be used. The time t_{A} taken by the drone 100c having returned to be replenished or refreshed with the decreasing factors, which include replenishment with chemical agent or electric recharging in this example, and to take off again can be calculated from a state of the drone 100c having returned, a rate of replenishment with chemical agent and a rate of electric recharging. The time t_{B} taken to allocate all remaining operations to the drones 100a and 100b not having returned and cause the drones 100a and 100b not having returned to perform all remaining operations can be calculated by calculating all remaining operations from the degrees of progress of the operations by the drones 100a, 100b, and 100c described above, making reference to operational efficiencies of the drones 100a and 100b not having returned, and dividing all remaining operations by the operational efficiencies.

Note that the redistribution of all remaining operations may be determined based on an estimated required time on all remaining operations or may be determined based on estimated remaining amounts of the decreasing factors. That is, in a case where the estimated remaining amounts of the decreasing factors of the drones 100a and 100b not having returned are sufficient for the drones 100a and 100b even when all remaining operations are evenly distributed to the drones 100a and 100b, all remaining operations can be evenly divided based on the estimated required time, which makes it possible to complete the operations in the shortest time. In contrast, in a case where evenly distributing all remaining operations to the drones 100a and 100b not having returned will make an estimated remaining amount of the decreasing factor of any one of these drones 100a and 100b insufficient for the one of the drones 100a and 100b, but changing a distribution ratio allows the other to compensate for the insufficiency, it is possible to change a distribution ratio in accordance with the estimated remaining amounts to distribute all remaining operations.

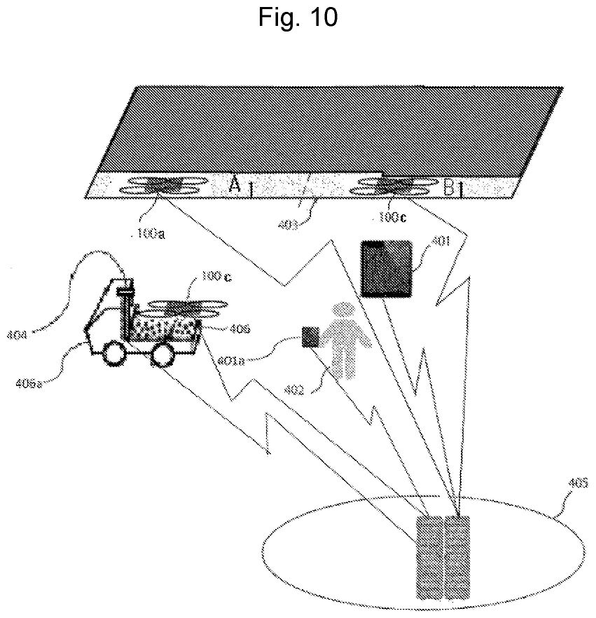

FIG. 10 schematically illustrates a state where the allocation of the assigned zones to the drones is reviewed when at least one of the drones returns to the takeoff-landing port, and redistribution is performed due to satisfaction of conditions. That is, when it is determined that t_{A}>t_{B} is satisfied and that the chemical agent amounts and charge amounts of the drones 100a and 100b not having returned are sufficient for the drones 100a and 100b not having returned to perform all remaining operations, all remaining operations, in other words, a remaining area in the agricultural field 403, are newly redistributed to the drones 100a and 100b, the drones 100a and 100b are given new operating zones A1 and B1, the flight routes are updated accordingly, and the drones 100a and 100b are operated along the new flight routes.

In contrast, in a case where the result of the comparison shows that t_{A}>t_{B} is not satisfied, or the factors held by the drones 100b and 100c not having returned, that is, the chemical agent amounts and the charge amounts, are insufficient for the drones 100b and 100b not having returned to perform all remaining operations, the original operating segments (zone A, zone B, and zone C) are unchanged, and the drone 100c having returned takes off again to continue performing the remaining operation in the zone C after replenishment with chemical agent and electric recharging are finished.

In the above description, the return of the drone 100c to the takeoff-landing port 406 is caused due to the need of replenishment with chemical agent, electric recharging, or the like; however, also in a case where the return of the drone is based on an optional return command from an operator, the allocation of the assigned zones to the drones may be reviewed similarly at this time, that is, when at least one of the drones returns to the takeoff-landing port. In this case, the determination including the calculation and comparison of t_{A} and t_{B} as described above is not necessary, and thus it is possible to allocate and redistribute all remaining operations immediately to drones not having returned and change the flight routes of the drones.

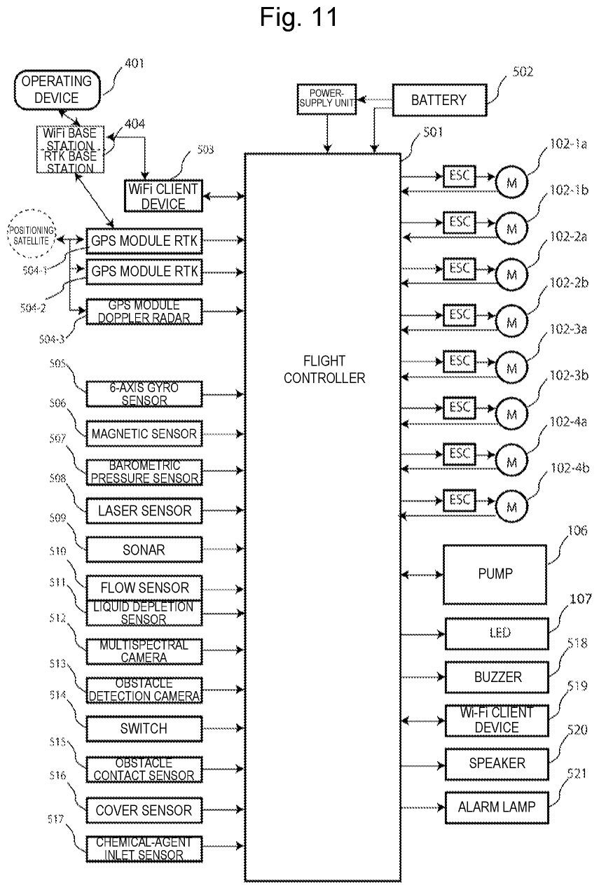

FIG. 11 is a block diagram illustrating control functions in an embodiment of a drone for spreading chemical agent according to the invention of the present application. A flight controller 501 is a constituent component that governs control of the entire drone; specifically, the flight controller 501 may be an embedded computer including a CPU, a memory, relevant software, and the like. The flight controller 501 controls a flight of a drone 100 by controlling the numbers of revolutions of the motors 102-1a, 102-1b, 102-2a, 102-2b, 102-3a, 102-3b, 104-a, and 104-b via control means such as an electronic speed control (ESC) based on input information received from the operating device 401 and input information obtained from various kinds of sensors described later. The flight controller 501 is configured to receive feedback on actual numbers of revolutions of the motors 102-1a, 102-1b, 102-2a, 102-2b, 102-3a, 102-3b, 104-a, and 104-b so as to monitor whether their rotations are normal. Alternatively, the flight controller 501 may be configured to receive feedback on the rotations of the rotary wings 101 from optical sensors or the like provided at the rotary wings 101.

Software used for the flight controller 501 can be rewritten for enhancement/modification of a function, fixing a problem, or the like via a storage medium or the like or communication means such as Wi-Fi communication and USB. In this case, the software is protected by means of encryption, checksum, digital signature, virus-check software, and the like so as not to be rewritten by fraudulent software. In addition, calculation processing used by the flight controller 501 for the control may be partly executed by another computer that is present on the operating device 401 or the agriculture cloud 405 or at another location. Some or all of the constituent components of the flight controller 501 may be duplexed owing to its great importance.

The flight controller 501 can receive a necessary command from the operating device 401 and send necessary information to the operating device 401 by exchanging data with the operating device 401 via a Wi-Fi client unit function 503 and additionally the base station 404. In this case, the communication may be encrypted to prevent fraudulent activities such as interception, spoofing, and hacking a device. The base station 404 has a communication function using Wi-Fi as well as a function of an RTK-GPS base station. By combining a signal from the RTK base station and signals from GPS satellites, an absolute position of the drone 100 can be measured with a precision of about several centimeters by the flight controller 501. The flight controller 501 may be duplexed/multiplexed owing to their great importance; in addition, redundant flight controllers 501 may be controlled to use another satellite so as to prepare for failure of some GPS satellite.

A 6-axis gyro sensor 505 is means for measuring accelerations of the drone airframe in three directions orthogonal to one another and further means for calculating velocities by integrating the accelerations. The 6-axis gyro sensor 505 is means for measuring changes in attitude angles, namely, angular velocities, of the drone airframe in the three directions described above. A geomagnetic sensor 506 is means for measuring a direction of the drone airframe by measuring the Earth's magnetic field. A barometric pressure sensor 507 is means for measuring barometric pressure; the barometric pressure sensor 507 can also measure an altitude of the drone indirectly. A laser sensor 508 is means for measuring a distance between the drone airframe and the Earth's surface by using reflection of laser light; the laser sensor 508 may use infrared (IR) laser. A sonar 509 is means for measuring a distance between the drone airframe and the Earth's surface by using reflection of a sound wave such as an ultrasonic wave. These sensors and the like may be selected in accordance with a cost target and performance requirements of the drone. In addition, a gyro sensor (angular velocity sensor) for measuring an inclination of the airframe, an anemometer sensor for measuring a force of wind, and the like may be added. These sensors and the like may be duplexed or multiplexed. In a case where there are a plurality of sensors provided for the same purpose, the flight controller 501 may use only one of the sensors, and if a failure occurs in the one, another one of the sensors may be switched to and used as an alternative sensor. Alternatively, the flight controller 501 may use the plurality of sensors simultaneously, and if measurement results from the sensors disagree, the flight controller 501 may deem that a failure has occurred.

Flow sensors 510 are means for measuring flow rates of chemical agent and are provided at a plurality of locations on channels from the chemical agent tank 104 to the chemical agent nozzles 103. A liquid depletion sensor 511 is a sensor for sensing whether a chemical agent amount has fallen to or below a predetermined amount. A multispectral camera 512 is means for capturing an image of the agricultural field 403 to acquire data to be used for image analysis. An intruder detection camera 513 is a camera for detecting an intruder for the drone; the intruder detection camera 513 is a device of a different kind from that of the multispectral camera 512 because its image properties and an orientation of its lens are different from those of the multispectral camera 512. A switch 514 is means with which the user 402 of the drone 100 makes various settings. An intruder contact sensor 515 is a sensor for detecting that the drone 100, particularly a portion of its rotor or its propeller guard has come into contact with an intruder such as an electric wire, a building, a human body, a tree, a bird, and another drone. Note that the 6-axis gyro sensor 505 may substitute for the intruder contact sensor 515. A cover sensor 516 is a sensor for detecting that a cover of an operation panel or a cover for an internal maintenance of the drone 100 is in an open state. A chemical-agent inlet sensor 517 is a sensor for detecting that an inlet of the chemical agent tank 104 is in an open state. These sensors and the like may be selected in accordance with a cost target and performance requirements of the drone and may be duplexed or multiplexed. In addition, a sensor may be provided in the base station 404, the operating device 401, or another location outside of the drone 100, and information read by the sensor may be sent to the drone. For example, an anemometer sensor may be provided in the base station 404, and information concerning a force and a direction of wind may be sent to the drone 100 via Wi-Fi communication.

The flight controller 501 sends a control signal to the pump 106 to adjust a chemical agent amount to be discharged or stop discharging the chemical agent. The flight controller 501 is configured to receive feedback on current conditions (e.g., the number of revolutions) of the pump 106.

An LED 107 is display means for informing an operator of the drone of a state of the drone. In place of or in addition to the LED, display means such as a liquid crystal display may be used. A buzzer 518 is output means for indicating the state (particularly an error state) of the drone using an aural signal. A Wi-Fi client unit function 519 is an optional constituent component that communicates with an external computer or the like to transfer, for example, software separately from the operating device 401. In place of or in addition to the Wi-Fi client unit function, other kinds of wireless communication means such as infrared communication, Bluetooth®, ZigBee® and NFC, or wired communication means such as USB connection may be used. In place of the Wi-Fi client unit function, a mobile telecommunications system such as 3G, 4G, and LTE may be used to enable the drone and the external computer to mutually communicate with each other. A speaker 520 is output means for indicating the state (particularly an error state) of the drone using recorded human voice, synthesized voice, or the like. In some weather conditions, a visual display by the drone 100 during flight is difficult to see; in this case, using voice to transmit the state is effective. An alarm lamp 521 is display means such as a strobe light for indicating the state (particularly an error state) of the drone. These kinds of input/output means may be selected in accordance with a cost target and performance requirements of the drone and may be duplexed or multiplexed.

Note that although the block diagram in FIG. 11 illustrating the control functions of the drone illustrates control functions of one drone, there are a plurality of drones used in the present invention, and it should be understood that there are sets of the control functions described above for the number of the drones.

Configuration of Movable Body

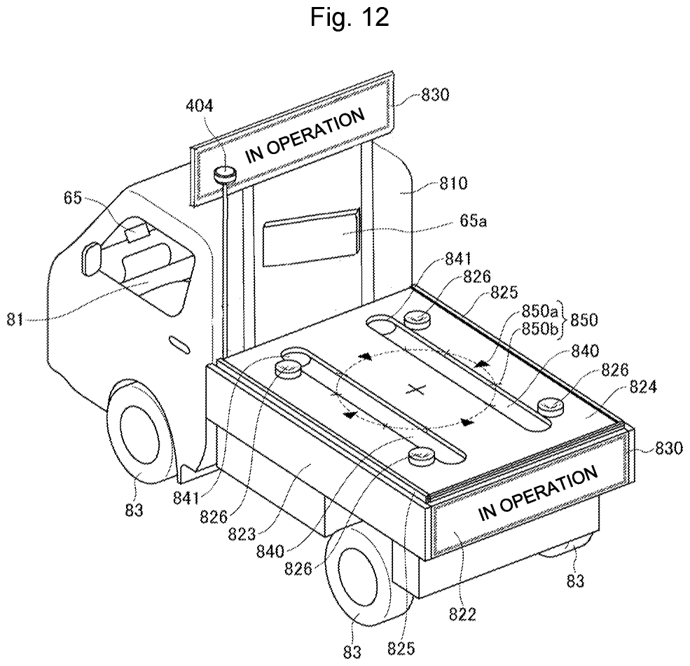

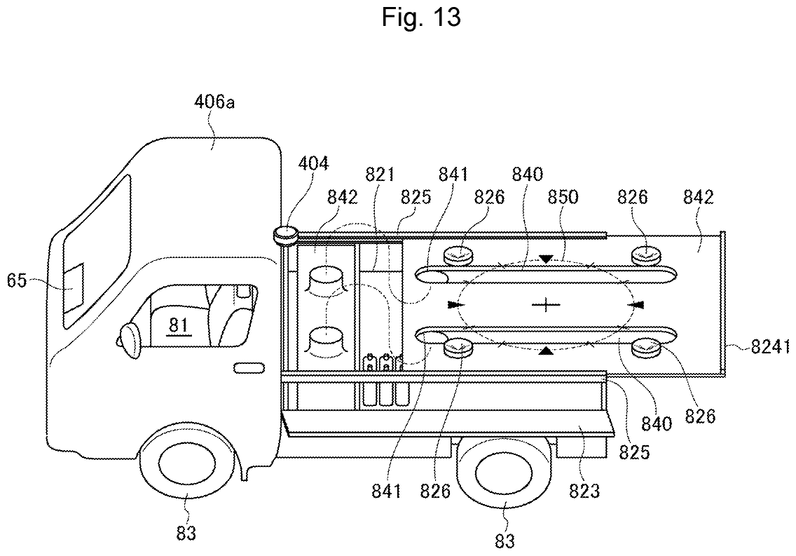

The movable body 406a illustrated in FIG. 12 and FIG. 13 is an apparatus that receives information possessed by the drones 100 and notifies the user 402 of the information as appropriate, and that accepts an input from the user 402 and sends the input to the drones 100. In addition, the movable body 406a is capable of moving with the drones 100 aboard. The movable body 406a is capable of being driven by the user 402 and may be capable of moving autonomously. Although the movable body 406a in the present embodiment is assumed to be a vehicle such as an automobile, more specifically a mini truck, the movable body 406a may be an appropriate land movable body such as a railroad car or may be a boat or an aerial vehicle. A driving source of the movable body 406a may be appropriate one using gasoline, electricity, fuel cells, or the like.

The movable body 406a is a vehicle in which an occupant seat 81 is arranged on a front side of the vehicle in its traveling direction and a platform 82 on a rear side of the vehicle in the traveling direction. On a bottom side of the movable body 406a, four wheels 83 are arranged to be capable of being driven; the wheels 83 exemplify moving means. The occupant seat 81 allows the user 402 to sit thereon.

In the vicinity of the occupant seat 81, a display section 65 that displays states of the movable body 406a and the drones 100 is arranged. The display section 65 may be a device with a screen or may be implemented as a mechanism that projects information onto a windshield. In addition to the display section 65, a back-side display section 65a may be installed on a back side of a vehicle body 810 with which the occupant seat 81 is covered. An angle of the back-side display section 65a can be changed laterally with respect to the vehicle body 810, allowing the user 402 working on a rear side or a lateral side of the platform 82 to acquire information by watching a screen of the rear-side display section 65a.

At a front left corner of the platform 82 of the movable body 406a, the base station 404, which has a shape made by joining a disk-like member to an upper end of a round bar, extends upward to be higher than the occupant seat 81. Note that the base station 404 may have any shape and may be located at any position. With the configuration in which the base station 404 is located on the occupant seat 81 side of the platform 82, the base station 404 is unlikely to hinder the drones 100 from making a takeoff and a landing, as compared with a configuration in which the base station 404 is located on a rear side of the platform 82.

The platform 82 has a trunk 821 for storing batteries 502 for each drone 100 and chemical agent with which the chemical agent tank 104 of the drone 100 is to be replenished. The trunk 821 is a space surrounded by the vehicle body 810 with which the occupant seat 81 is covered, a rear plate 822, a pair of side plates 823 and 823, and an upper plate 824. The rear plate 822 and the side plates 823 are also called “gates”. On upper portions of both edges of the rear plate 822, rails 825 are disposed, extending along upper edges of the side plates 823 up to the vehicle body 810 on the back side of the occupant seat 81. The upper plate 824 serves as a takeoff-landing area being the takeoff-landing port 406, which allows the drones 100 to be placed thereon and to make a takeoff and a landing; the upper plate 824 is slidable forward and backward in the traveling direction along the rails 825. The rails 825 serve as ribs that protrude upward from a plane of the upper plate 824, preventing the drones 100 placed on the upper plate 824 from slipping out from right and left edges of the movable body 406a. In addition, a rib 8241 that protrudes upward to the same extent as the rails 825 is formed on a rear side of the upper plate 824.

At an upper portion of the vehicle body 810 and on a rear side of the rear plate 822 in the traveling direction, an alarm lamp 830 displaying a notice of the drone system 500 being in operation may be arranged. The alarm lamp 830 may be a display that distinguishingly displays a notice that the drone system 500 is in operation and a notice that the drone system 500 is not in operation by using colors, turning on and off, or the like, or may be capable of displaying characters or pictures. The alarm lamp 830 at the upper portion of the vehicle body 810 may be capable of stretching up above the vehicle body 810 and providing a display on both sides of the alarm lamp 830. With this configuration, a warning can be visually recognized from the rear even when the drones 100 are placed on the platform 82. In addition, the warning can be visually recognized from ahead of the movable body 406a in the traveling direction. Since the alarm lamp 830 can be visually recognized from the front and the rear, time and trouble to place the demarcating members 407 can be partially saved.

The upper plate 824 may be manually slidable or may automatically slide by a rack-and-pinion mechanism or the like. By sliding the upper plate 824 rearward, an item can be put into the trunk 821 from above the platform 82 or can be taken out from the trunk 821. In a mode where the upper plate 824 is slid rearward, the upper plate 824 and the vehicle body 810 are sufficiently separated from each other, and thus each drone 100 can take off from and make a landing on the takeoff-landing port 406.

On the upper plate 824, four leg receiving members 826 to which the legs 107-1, 107-2, 107-3, and 107-4 of each drone 100 can be fixed are arranged. The leg receiving members 826 are, for example, disk-like members that are placed at positions corresponding to the four legs 107-1, 107-2, 107-3, and 107-4 of each drone 100, and each of which has an upper face that recesses in a truncated-cone shape. Bottoms of truncated-cone-shaped recesses of the leg receiving members 826 and tips of the legs 107-1, 107-2, 107-3, and 107-4 may be shaped such that each bottom and a corresponding tip fit together. When landing on the leg receiving members 826, the legs 107-1, 107-2, 107-3, and 107-4 of each drone 100 slide on conical surfaces of the leg receiving members 826, so that tips of the legs 107-1, 107-2, 107-3, and 107-4 are guided to bottom portions of the truncated cones. Each drone 100 can be fixed to the leg receiving members 826 automatically or manually by an appropriate mechanism, so that when the movable body 406a moves with the drone 100 aboard, the drone 100 can be transported safely without excessively shaken or dropped. The movable body 406a can sense whether each drone 100 is fixed to the leg receiving members 826.

Substantially at a center portion of the upper plate 824, a circle light 850 that displays a guide to a takeoff-landing position for each drone 100 is arranged. The circle light 850 is formed with lamps that are arranged substantially in a circular pattern, and the lamps can each turn on and off individually. In the present embodiment, a circle light 850 is constituted of four large lamps 850a that are arranged every about 90 degrees and small lamps 850b every two of which are arranged between adjacent large lamps 850a at equal intervals. The circle light 850 displays a flying direction after each drone 100 makes a takeoff or a flying direction in which each drone 100 makes a landing by lighting one or more of the lamps 850a and 850b. The circle light 850 may be constituted of one annular lamp that can partly turn on or off.

The pair of side plates 823 is coupled to the platform 82 at its bottom edges with hinges, by which the side plates 823 can be laid down outward. FIG. 13 illustrates how a side plate 823 on the left side in the traveling direction is laid down outward. After the side plate 823 is laid down outward, it is possible to put an item to be stored or take out a stored item through a lateral side of the movable body 406a. The side plates 823 can be fixed to be substantially parallel to a bottom face of the trunk 821, so that the side plates 823 are available as workbenches.

A pair of the rails 825 forms a mode switching mechanism. The hinges used to couple the side plates 823 to the platform 82 may be included in the mode switching mechanism. In a mode in which the upper plate 824 is arranged to cover above the trunk 821, and the side plates 823 are erected to cover lateral faces of the trunk 821, the movable body 406a moves. When the movable body 406a is at a stationary, the movable body 406a can be switched to a mode in which the upper plate 824 is slid rearward or a mode in which the side plates 823 are laid down, where the user 402 can approach an inside of the trunk 821.

While each drone 100 is on the takeoff-landing port 406, replenishment with a battery 502 can be performed. The replenishment with a battery 502 includes charging the battery 502 built in and replacing the battery 502. In the trunk 821, a charging device for batteries 502 is stored and can charge batteries 502 stored in the trunk 821. Alternatively, each drone 100 may include a mechanism of an ultracapacitor in place of the battery 502, and a charger for the ultracapacitor may be stored in the trunk 821. In this configuration, while each drone 100 is fixed to the leg receiving members 826, the battery 502 equipped with the drone 100 can be fast-charged via the legs of the drone 100.

While each drone 100 is on the takeoff-landing port 406, the chemical agent tank 104 can be replenished with chemical agent to be reserved in the chemical agent tank 104. In the trunk 821, appropriate constituent components for dilution and mixing may be stored, such as a dilution-mixing tank for diluting and mixing chemical agent, a stirring mechanism, a pump and a hose for sucking the chemical agent from the dilution-mixing tank and pouring the chemical agent into the chemical agent tank 104. In addition, a replenishment hose that extends upward from the trunk 821 above the upper plate 824 and can be connected to an inlet of the chemical agent tank 104 may be provided.

On an upper-surface side of the upper plate 824, liquid-waste ditches 840 and liquid-waste holes 841 that guide chemical agent discharged from the chemical agent tank 104 are formed. The numbers of the liquid-waste ditches 840 and liquid-waste holes 841 arranged are each two, so that a liquid-waste ditch 840 is located below the chemical agent nozzles 103 irrespective of whether each drone 100 lands on the movable body 406a facing the right or the left. The liquid-waste ditches 840 are ditches with a predetermined width that are formed substantially straight, pass positions of the chemical agent nozzles 103, extend along a lengthwise direction of the movable body 406a, and are slightly inclined toward the occupant seat 81. At ends of the liquid-waste ditches 840 on the occupant seat 81 side, the liquid-waste holes 841 that penetrate the upper plate 824 to guide chemical solution into the inside of the trunk 821 are formed. The liquid-waste holes 841 communicate with a liquid-waste tank 842 that is installed inside the trunk 821 and substantially directly below the liquid-waste holes 841.

Before chemical agent is poured into the chemical agent tank 104, an air bleeding operation to discharge gas, mainly air, filling the chemical agent tank 104 to the outside is performed. At this time, an operation to discharge chemical agent from an outlet of the chemical agent tank 104 is needed. In addition, after each drone 100 completes its operation, an operation to discharge chemical agent from the chemical agent tank 104 is needed. With the configuration in which the upper plate 824 is formed with the liquid-waste ditches 840 and the liquid-waste holes 841, when chemical agent is poured into or discharged from the chemical agent tank 104 while each drone 100 is placed on the upper plate 824, liquid waste can be guided to the liquid-waste tank 842, so that the chemical agent can be poured and discharged safely.

Outline of Functional Blocks Included in Drone and Movable Body

The movable body 406a includes a movement control section 30, a movable-body position detection section 32, an area determining section 33, a stop position determining section 34, and a position transmission section 35.

The movement control section 30 is a functional section that controls movement and stoppage of the movable body 406a. The movement control section 30 can cause the movable body 406a to move and stop autonomously within the automatic-driving permitted area based on, for example, information on position coordinates and an ambient environment of the movable body 406a. In addition, the movement control section 30 can acquire, for example, information concerning a moving route from the agriculture cloud 405 and can cause, based on the information, the movable body 406a to move and stop. Note that the movement control section 30 may be controlled autonomously or may be controlled manually from a driver's seat of the movable body 406a or the outside of the movable body 406a.

The movable-body position detection section 32 is a functional section that detects current position coordinates of the movable body 406a. The movable-body position detection section 32 can detect the position coordinates of the movable body 406a continuously or periodically.

The area determining section 33 is a functional section that determines whether the movable body 406a is positioned within a region where a drone 100 can land on the movable body 406a, that is, a landing permitted area. The area determining section 33 can determine a position of the movable body 406a continuously or periodically. The area determining section 33 determines an area where the movable body 406a is located by comparing information on the landing permitted area that is set in advance with the position coordinates of the movable body 406a obtained by RTK-GPS or the like. In a case where a stop position of the movable body 406a is determined, the area determining section 33 may additionally determine an area where the stop position is located.

The stop position determining section 34 is a functional section that receives, if any accident occurs for example, information on the accident and determines the stop position of the movable body 406a. When the information is received, the stop position determining section 34 causes the movable body 406a to stop. The stop position determining section 34 may stop the operation of the movable body 406a upon the reception of the information. With this configuration, it is possible to stop the operation immediately, and thus a high safety can be guaranteed.

The stop position determining section 34 may determine the stop position based on an area where the movable body 406a is located. In a case where the movable body 406a is positioned within the movement permitted area 901, the stop position determining section 34 may determine that the movable body 406a is to move to and stop at a closest point in the landing permitted area 902. With this configuration, it is possible to cause the drone 100 returning from the agricultural field 403 to land on the movable body 406a reliably.

The position transmission section 35 is a functional section that sends information on a position at which the movable body 406a stops to a movable-body stop position receiving section 22 of the drone 100. The information on the position of the stop may be received by the operating device 401 and the small portable terminal 401a and may be displayed on the display sections of the operating device 401 and the small portable terminal 401a as appropriate. The position transmission section 35 may additionally send a type of an area where the stop position is located, the area being determined by the area determining section 33, that is, the information as to whether the stop position of the movable body 406a is within a region where the drone 100 can make a landing.

The drone 100 includes the flight control section 21, the movable-body stop position receiving section 22, and a landing position determining section 23.

The flight control section 21 is a functional section that operates the motors 102 to control a flight, and a takeoff and a landing of the drone 100.

The movable-body stop position receiving section 22 is a functional section that receives the information on the stop position of the movable body 406a sent from the position transmission section 35. The movable-body stop position receiving section 22 additionally receives information as to whether the stop position of the movable body 406a is within a region where the drone 100 can make a landing. Note that in a case where the drone system 500 includes a plurality of movable bodies 406a, the movable-body stop position receiving section 22 receives pieces of identification information that make movable bodies identifiable as well as information on positions of the movable bodies and types of areas where stop positions of the movable bodies are located. The movable-body stop position receiving section 22 may receive only information on the position of the movable body on which the drone 100 is to land and the type of the area where the position of the movable body is located.

The landing position determining section 23 is a functional section that determines a position at which the drone 100 is to make a landing based on the stop position of the movable body 406a. The landing position determining section 23 refers to position coordinates at which the movable body 406a is stopping and determines that the drone 100 is to land on the movable body 406a at the position coordinates.

While the drone 100 is flying, the landing position determining section 23 determines an exit point through which the drone is to exit the operation area of the drone 100, that is, the agricultural field 403, as the landing position of the drone 100. Alternatively, the landing position determining section 23 may determine the landing position of the drone 100 during an operation in the agricultural field 403. The landing position determining section 23 may perform a process of determining the landing position based on that the drone 100 is planned to make a landing or exit the agricultural field 403 within a predetermined time.

Note that in the case where the drone system 500 includes a plurality of movable bodies 406a, the landing position determining section 23 may determine the landing position of the drone 100 based on the stop position of the movable body at which the landing of the drone 100 including the landing position determining section 23 is planned. In a case where the drone 100 cannot make a landing on the movable body at which the landing is planned, the landing position determining section 23 may determine that the drone 100 is to make a landing on an alternate movable body.

Flowchart

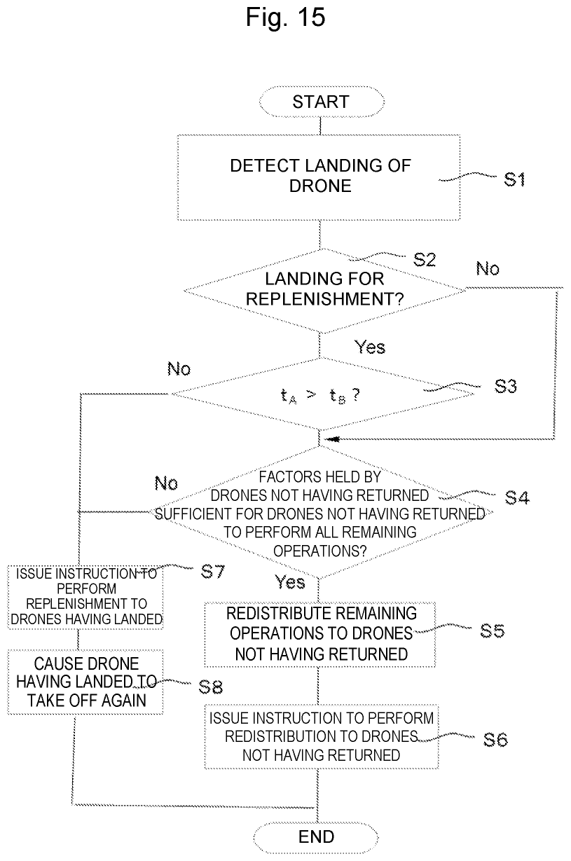

Behaviors of components having features in the embodiment described above will be described. As illustrated in FIG. 15, return of the drone 100c to the takeoff-landing port 406 of the movable body 406a is first detected (S1).

In accordance with the return of the drone 100c to the takeoff-landing port 406, it is determined whether the return is for the purpose of replenishment or refreshment with the decreasing factors (replenishment with chemical agent and electric recharging) (S2).

In a case where it is determined in S1 that the return is for the purpose of replenishment or refreshment with the decreasing factors, the time t_{A} taken to be replenished with chemical agent or charged and to take off again and the time t_{B} taken to allocate all operations remaining at a time of the return to the drones 100a and 100b not having returned and cause the drones 100a and 100b not having returned to perform all remaining operations are calculated and compared with each other, and it is determined whether the comparison results in t_{A}>t_{B} (S3).

In contrast, in a case where it is determined in S2 that the return is not for the purpose of replenishment or refreshment with the decreasing factors but is caused by an optional action by an operator, S3 is skipped.

In a case where a condition that establishes t_{A}>t_{B} is satisfied in S3, it is further determined whether the factors held by the drones not having returned are sufficient for the drones not having returned to perform all remaining operations (S4).

The determination in S4 is performed also in a case where it is determined in S2 that the return is not for the purpose of replenishment or refreshment with the decreasing factors.

In a case where it is determined in S4 that the factors held by the drones not having returned are sufficient for the drones not having returned to perform all remaining operations, a process of redistributing all remaining operations between the drones 100a and 100b not having returned is performed (S5), the drones 100a and 100b not having returned are instructed on this redistribution (S6), so that the remaining operations are performed by the drones 100a and 100b not having returned.

In contrast, in a case where the conditions are not satisfied in S3 or S4, an instruction to perform replenishment of the drone 100c having returned are issued (S7), after the replenishment, the drone 100c having returned is caused to take off again (S8), so that the remaining operations are performed by the three drones 100a, 100b, and 100c in accordance with the original zones.

Although the present description has been made about a drone for spreading an agricultural chemical agent as an example, note that a technical concept of the present invention is not limited to this example and is applicable generally to drones for other uses such as photographing and monitoring. In particular, the technical concept is applicable to machinery that operates autonomously.

### TECHNICALLY ADVANTAGEOUS EFFECTS OF THE INVENTION OF THE PRESENT APPLICATION

In the drone system according to the invention of the present application, in a case where a plurality of drones are used to perform operations along flight routes that are assigned to the drones for areas on which the operations are to be performed, even when a difference arises in operation progress status among the drones, allocation of the operations to the drones can be redistributed, so that it is possible to bring efficiency to the operations, and an operating time can be shortened. Furthermore, even in a case where an operator optionally withdraws one or more of the drones, it is possible to complete the remaining operations smoothly.

1. A drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner, wherein
when at least one of the drones returns to the takeoff-landing port, the drone system allocates and redistributes at least part of a remaining operation to drones not having returned and changes a flight route of at least one of the drones not having returned.

2. A drone system wherein the changed flight route is different from a contracted original flight route as a remaining operation for the drone having returned.

3. The drone system according to claim 1, wherein the changed flight route is determined by setting a flight route again based on a remaining area corresponding to the original flight route.

4. The drone system according to claim 1, wherein
each of the plurality of drones holds at least one decreasing factor that is to be consumed when a corresponding drone is operated, and on condition that replenishment or refreshment with the factor needs return to the takeoff-landing port,
when at least one of the drones returns to the takeoff-landing port, in a case where it is determined that the factor held by each of drones not having returned is sufficient for the drones not having returned to perform all remaining operations, the drone system allocates and redistributes all remaining operations to the drones not having returned and changes flight route of the drones.

5. The drone system according to claim 4, wherein the decreasing factor is at least one selected from the group consisting of an amount of driving energy of a drone and an amount of substance loaded in the drone.

6. The drone system according to claim 4, wherein in a case where a return of the at least one of the drones to the takeoff-landing port is for replenishment or refreshment with the decreasing factor, the drone system calculates and compares a time t_{A} and a time t_{B}, the time t_{A} being a time taken by the at least one of the drones to be replenished or refreshed with the decreasing factor and to take off again, the time t_{B} being a time taken to allocate all operations remaining at a time of the return to drones not having returned and cause the drones not having returned to perform all remaining operations, and determines whether to redistribute all remaining operations to the drones not having returned based on at least a result of the comparison.

7. The drone system according to claim 6, wherein in a case where the comparison of t_{A} and t_{B} results in t_{A}>t_{B}, and it is determined that the factor held by each of drones not having returned is sufficient for the drones not having returned to perform all remaining operations, the drone system allocates and redistributes all remaining operations to the drones not having returned and changes flight routes of the drones.

8. The drone system according to claim 4, wherein a return of the at least one of the drones to the takeoff-landing port is based on an optional return command from an operator.

9. The drone system according to claim 6, wherein the drone system switches whether to compare t_{A} and t_{B} in accordance with whether a return of the at least one of the drones to the takeoff-landing port is for replenishment or refreshment with the decreasing factor or based on an optional return command from an operator.

10. The drone system according to claim 9, wherein
in accordance with whether a return of the at least one of the drones to the takeoff-landing port is for replenishment or refreshment with the decreasing factor or based on an optional return command from an operator,
in a case where the comparison of t_{A} and t_{B} shows that t_{A}>t_{B}, and it is determined that the factor held by each of drones not having returned is sufficient for the drones not having returned to perform all remaining operations,
the drone system switches between conditions including:
a condition of allocating and redistributing all remaining operations to the drones not having returned and changing the flight routes of the drones; and
a condition of allocating and redistributing all remaining operations immediately to the drones not having returned and changing the flight routes of the drones.

11. The drone system according to claim 4, wherein redistribution of all remaining operations is determined based on an estimated required time on all remaining operations or determined based on an estimated remaining amount of the decreasing factor.

12. The drone system according to claim 4, wherein the redistribution is an allocation performed by newly setting an optimum route again based on a remaining area rather than allocation by allocating an original route for the drone having returned in a shared manner.

13. The drone system according to claim 4, wherein each drone detects a state of the decreasing factor of the corresponding drone and transmits the state to the flight control section whenever necessary.

14. The drone system according to claim 1, wherein the takeoff-landing port is provided on a movable body that is capable of moving with the drone aboard and operates in coordination with the drone.

15. A control method for a drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner, the control method comprising
a step of allocating and redistributing, when at least one of the drones returns to the takeoff-landing port, at least part of a remaining operation to drones not having returned and changing a flight route of at least one of the drones not having returned.

16. The control method for a drone system according to claim 15, wherein
each of the plurality of drones holds at least one decreasing factor that is to be consumed when a corresponding drone is operated, and
the control method comprising:
on condition that replenishment or refreshment with the factor needs a return to the takeoff-landing port:
a step of detecting all remaining operations when at least one of the drones returns to the takeoff-landing port; and
a step of allocating and redistributing all detected remaining operations to drones not having returned and changing flight routes of the drones.

17. The control method for a drone system according to claim 16, further comprising:
a step of calculating and comparing, when at least one of the drones returns to the takeoff-landing port, a time t_{A} and a time t_{B}, the time t_{A} being a time taken by the drone having returned to be replenished or refreshed with the decreasing factor and to take off again, the time t_{B} being a time taken to allocate all operations remaining at a time of the return to drones not having returned and cause the drones not having returned to perform all remaining operations; and
a step of determining whether the comparison results in t_{A}>t_{B} and the factor held by each of drones not having returned is sufficient for the drones not having returned to perform all remaining operations,
wherein the drone system performs, in accordance with a result of the determination, the step of allocating and redistributing all detected remaining operations to drones not having returned and changing flight routes of the drones.

18. A control program for a drone system that includes a plurality of drones, at least one takeoff-landing port allowing the plurality of drones to take off or make a landing individually or allowing two or more of the plurality of drones to take off or make a landing simultaneously, and a flight control section controlling flights of the drones along flight routes assigned to the drones, the drone system causing the plurality of drones to perform an operation in a predetermined area in a sharing manner,
the control program causing a computer to execute a command to allocate and redistribute, when at least one of the drones returns to the takeoff-landing port, at least part of a remaining operation to drones not having returned and change a flight route of at least one of the drones not having returned.

19. The control program for a drone system according to claim 18, wherein
each of the plurality of drones holds at least one decreasing factor that is to be consumed when a corresponding drone is operated,
the control program causes a computer to execute, on condition that replenishment or refreshment with the factor needs a return to the takeoff-landing port:
a command to detect all remaining operations when at least one of the drones returns to the takeoff-landing port; and
a command to allocate and redistribute all detected remaining operations to drones not having returned and change flight routes of the drones.

20. The control program for a drone system according to claim 19, the control program causing a computer to execute:
a command to detect all remaining operations; a command to calculate and compare a time t_{A} and a time t_{B}, the time t_{A} being a time taken by the drone having returned to be replenished or refreshed with the decreasing factor and to take off again, the time t_{B} being a time taken to allocate all operations remaining at a time of the return to drones not having returned and cause the drones not having returned to perform all remaining operations;
a command to determine whether the comparison results in t_{A}>t_{B} and the factor held by each of drones not having returned is sufficient for the drones not having returned to perform all remaining operations; and
a command to allocate and redistribute all remaining operations to drones not having returned and change flight routes of the drones.

21. A drone that is capable of taking off from and making a landing on a takeoff-landing port and capable of flying along an assigned flight route while being controlled by a flight control section, the drone holding at least one decreasing factor that is to be consumed when the corresponding drone is operated, the drone including: a detection section that detects a state of the decreasing factor; and a transmission section that transmits state information obtained by the detection section to the flight control section whenever necessary, wherein the drone changes the flight route in accordance with a change of the flight route transmitted from the flight control section.
